(19) United States
(12) Patent Application Publication
(10) Pub. No.: US 2002/0194041 A1
(43) Pub. Date: Dec. 19, 2002

(54) Documenting and communicating system and method

(76) Inventors: Karl Stephen Fessenden, Wilder, KY (US); Richard William Geibel, Cincinnati, OH (US); Eric Scott Huron, West Chester, OH (US); Chunilal Kerai, Cardiff, WLS (US); Neil Walbeof, Gwent, WLS (US); Jeffrey Paul Griffiths, Mid-Glam, WLS (US)

Correspondence Address: BARBARA JOAN HAUSHALTER, LAW OFFICE, 228 BENT PINES CT., BELLEFONTAINE, OH, 43311, US

(21) Appl. No.: 09/884,510

(22) Filed: Jun. 15, 2001

(51) Int. Cl. G06F 17/60; G06F 7/00; G06F 15/16; G06F 17/30

(52) U.S. Cl. 705/7; 707/2

(57) ABSTRACT

A system and method are proposed wherein all global locations of a group would have access to a central database of non-serviceability of components and component repair needs. An input wizard would be a front-end system used to ensure consistent relevant data is input into the central database from each location. A series of required data fields are entered for the database to accept the input. A series of options can be provided for each question to ensure consistent verbiage in the system. The electronic system can be web based or utilize some form of a common electronic network for storage. Once the data is in the central data warehouse, the system would be capable of generating reports on the data. These reports can be automatically emailed to or otherwise accessed by interested parties.

### BACKGROUND OF THE INVENTION

The present invention relates to a system to document and communicate non-serviceable hardware and repair developments, or engineering development opportunities.

Currently, non-serviceable hardware is tracked in individual, unconnected databases or spreadsheets, or using other tracking methods. There is no single database available to multinational corporations for collecting and accessing availability of all of the non-serviceable hardware, including within the corporation and at customer facilities. Each customer, overhaul site, repair facility, and storage center has its own system for documenting the parts or components within their facilities. Some of these systems are detailed, listing most of the information required to determine if a repair is possible. Other systems are less detailed, and lack the information an engineer would need to determine if the design of a new repair is possible. Due to the lack of a common database, there are lost opportunities for determining repair priorities. Parts can sit in various non-serviceable hold locations without engineering learning of the need for a repair. This, in turn, can result in revenue opportunities being lost.

It would be desirable to provide an electronic database for providing significant details of a part, including condition, ownership, quantity, etc., that is accessible to all global locations of a group.

### BRIEF SUMMARY OF THE INVENTION

A system is proposed wherein all global locations of a group would have access to a central database of components and repair needs. An input wizard would be a front-end system used to ensure consistent relevant data is input into the central database from each location. A series of required data fields are entered for the database to accept the input. A series of options can be provided for each question to ensure consistent verbiage in the system. The electronic system can be web based or utilize some form of a common electronic network for storage. Once the data is in the central data warehouse, the system would be capable of generating reports on the data. These reports can be automatically emailed to or otherwise accessed by interested parties.

Accordingly, the present invention provides a database for storing information relating to repair needs and non-serviceable hardware. The database incorporates significant details involving the part, such as its condition, the cost for a new part, ownership of the part, etc.

### BRIEF DESCRIPTION OF THE DRAWINGS

FIG. 1 is a schematic block diagram illustrating a component documenting and communicating system to track components for engineering opportunities;

FIG. 2 illustrates a part detail application of the system of FIG. 1;

FIG. 3 illustrates an engineering or development review application of the system of FIG. 1;

FIG. 4 illustrates a customer disposition determination application of the system of FIG. 1;

FIG. 5 illustrates a part status application of the system of FIG. 1;

FIG. 6 illustrates a customized output feature of the system of FIG. 1; and

FIG. 7 illustrates a search capability of the system of FIG. 1.

### DETAILED DESCRIPTION OF THE INVENTION

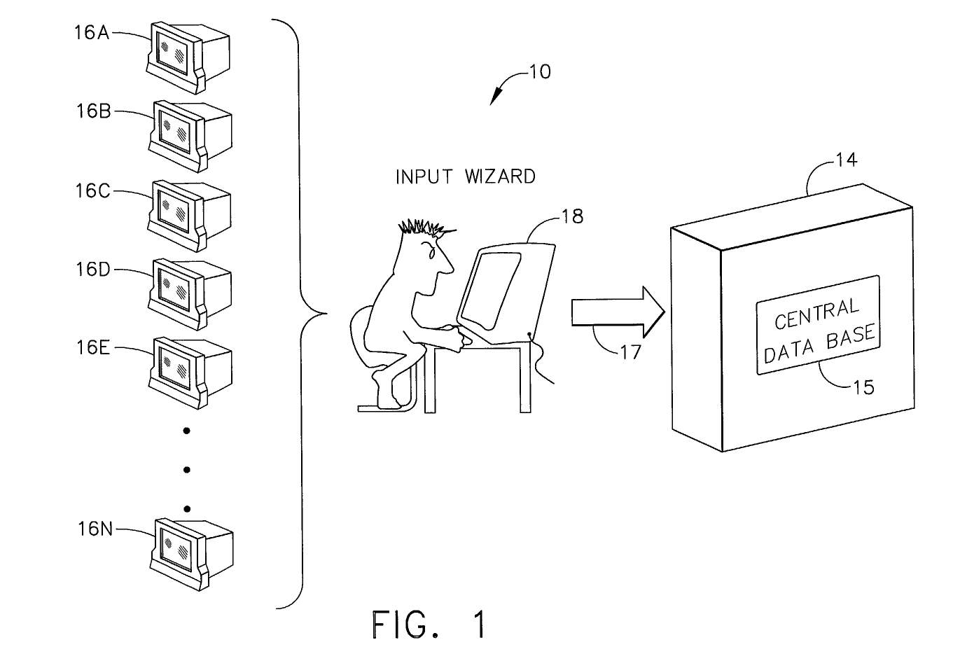

Referring to FIG. 1, there is a schematic block diagram illustrating a database arrangement 10 for storing accessible details on component hardware and repair needs related thereto, for which solutions are sought. The system 10 comprises one or more user computers 16A-16N that are representative of separate listings for each collaborator in the system. Each collaborative partner external to the entity or company owning the database will typically have access only to its own listing; while collaborative partners internal to the database ownership entity will typically have access to all of the data in the database. The listings can be updated online, as the collaborative partner provides information on its component storage and component repair needs. System 10 is configured to provide an online interface (website) whereby customers and repair shops can input repair needs and component part information, and obtain repair availability information. It will be obvious to those skilled in the art that the documenting and communicating concept of the present invention can be applied to a multitude of engineering or development type systems without departing from the scope of the invention.

The system 10 comprises a network interconnecting a server 14 and a plurality of users or collaborative partners 16A-16N. In one embodiment, the collaborative partners 16A-16N comprise computers having a web browser. Server 14 is accessible to collaborative partners 16A-16N via the Internet or an intranet. The server can be configured to store and download text and digital images. The users 16A-16N are interconnected to the Internet through any suitable interface such as dial-in-connections, cable modems, Internet access, special high-speed ISDN lines and networks such as local area networks (LANs) or wide area networks (WANs). Alternatively, the collaborative partners can be any client system capable of interconnecting to the Internet including a web-based phone or other web-based connectable equipment.

The listings can be updated online, as the collaborative partner inputs non-serviceable component information and repair needs. The structure of the system 10 allows for each collaborative partner 16A-16N to interface with the server 14, conveying non-serviceable component information to the central database 15, through an input means 18. The input means can comprise manual or automatic input means, including an input wizard. The interface includes an input portion and an output portion. The input portion of the interface is used to convey information from the collaborative partner computer to the server 14 and the database 15. Typically, the input information is generated by the user's actuation of an input peripheral, such as a mouse or a keyboard. The output portion conveys information from the server 14 to the collaborative partner computer and is typically displayed on the monitor of the collaborative partner computer. However, the output portion is capable of being displayed on other output peripherals, like printers.

The server 14 is configured with the database 15 of part related data, and further configured with a user interface 17 for allowing a user 16A-16N to input information into the database 15 for upload to the server 14. The interface 17 can be provided by any suitable means, such as by web pages that can be transmitted from the database to the user. The input information can include component non-serviceability documentation of the user. The user can also download information from the database 15, including repair development opportunities. The input means 18 filters information between the user 16A-16N and the server 14. The connection means or user interface 17 connects the computer of each collaborative partner 16A-16N to the server 14.

In a preferred embodiment, server 14 is configured to host a plurality of web pages that allow users and customers to enter repair needs and non-serviceable component information for upload to the server 14 via the input wizard 18. The input wizard 18 ensures consistent and relevant data is input to the server 14 and the database 15 from each user location. This is accomplished through use of a series of data fields requiring input information on the component and repair need. The separate collaborative partners each benefit from the expanded sources for data and the automatic prompting of the data fields for relevant input.

The server 14 can provide real time information on component non-serviceability and repair needs. Once the data is in the central database, the system 10 can generate reports on the data. These reports can be automatically emailed to or otherwise accessed by interested parties. Repair engineers are thereby provided with sufficient information to determine is the design of a new repair is possible or feasible. By collecting component non-serviceability information and repair needs from multiple locations into a central database, the information can be categorized to prioritize repair needs and repair development opportunities for an entire global entity.

Continuing with FIG. 1, the system 10 can comprise any kind of digital communication network or combination of digital communication networks. For example, the network can include a web browser, local area network (LAN), wide area network (WAN), World Wide Web, or any combination of these networks. Likewise, the user computers 16A-16N and the server 14 can be of any form so long as the repair development program information can be communicated between a user computer and the database 15 of server 14.

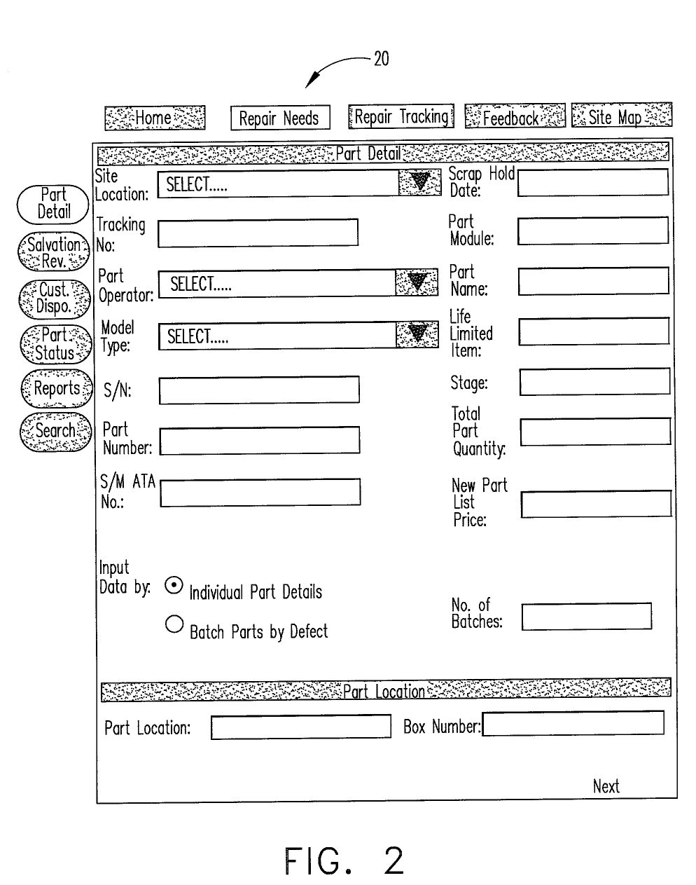

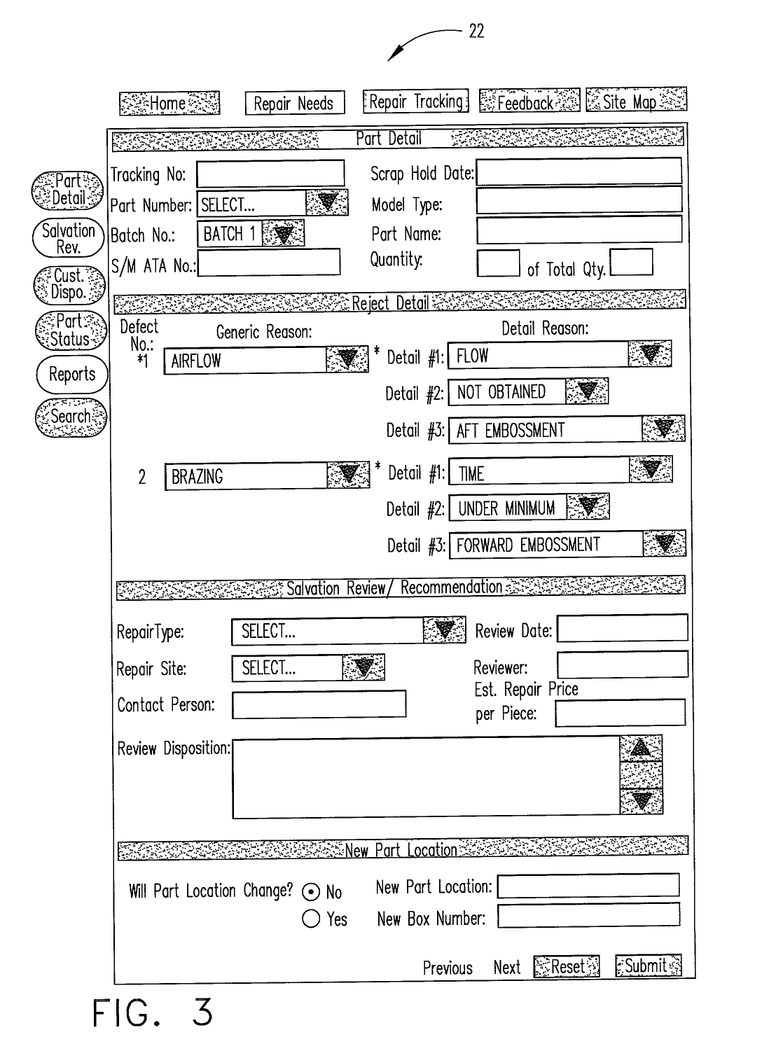

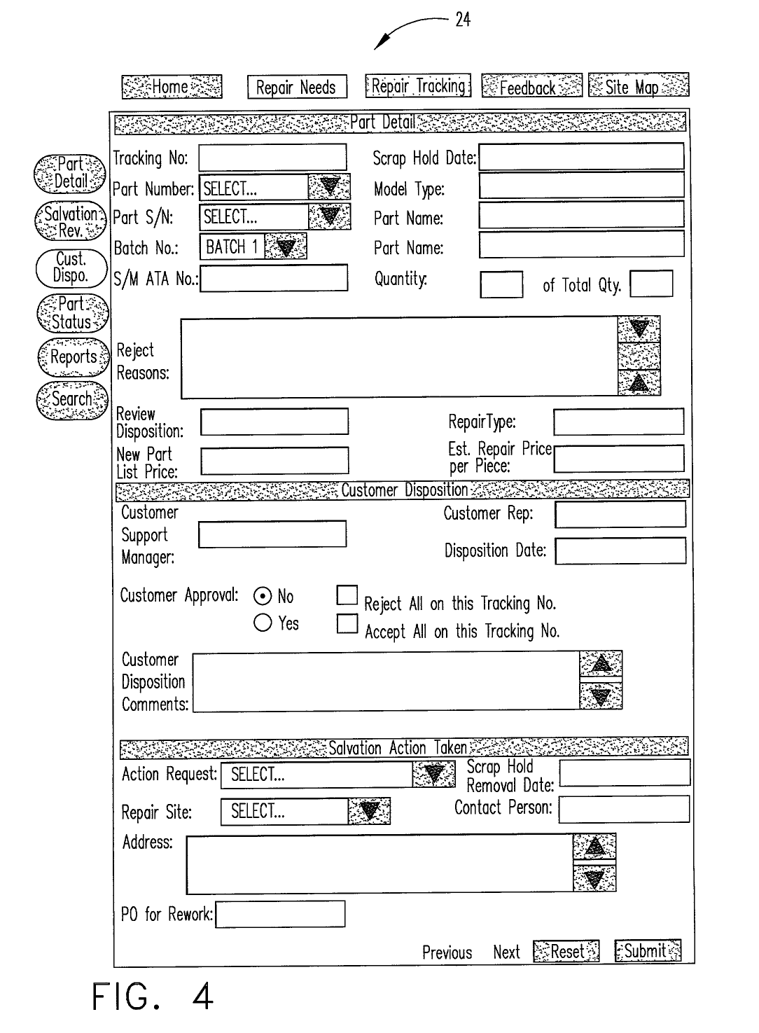

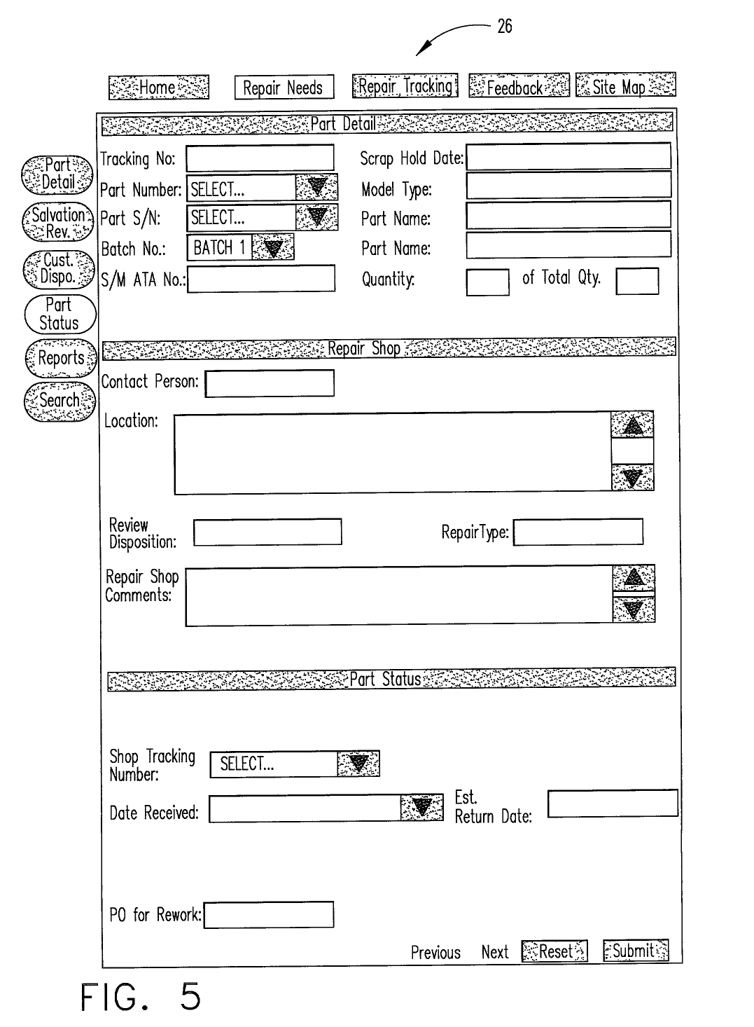

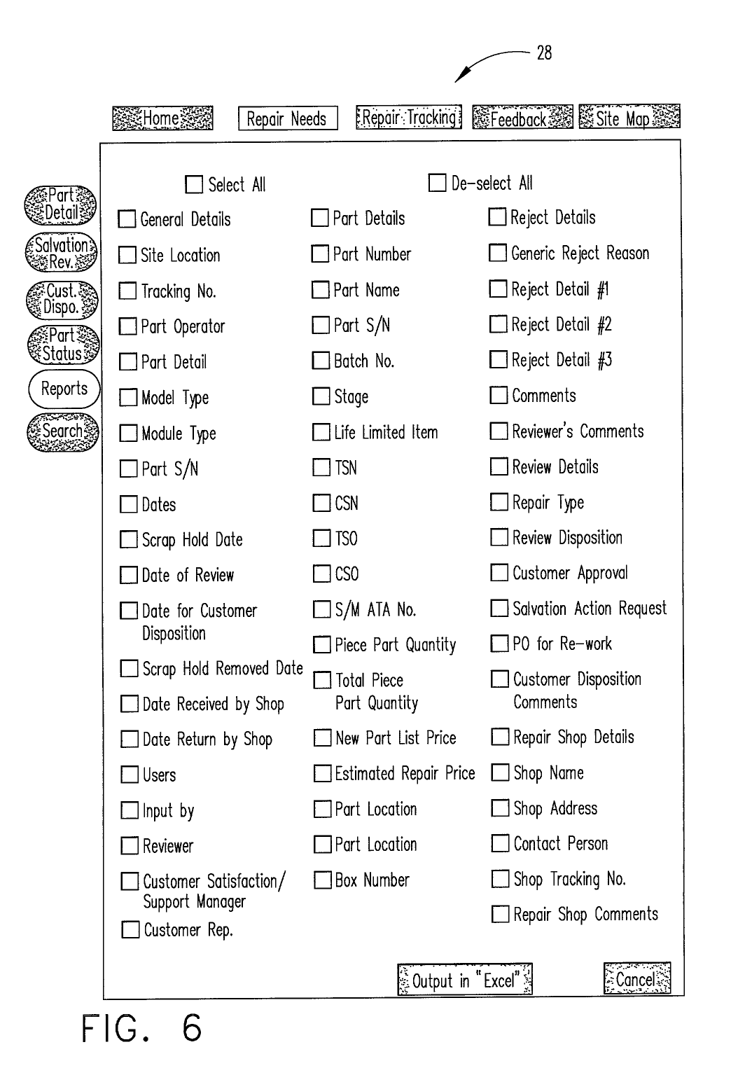

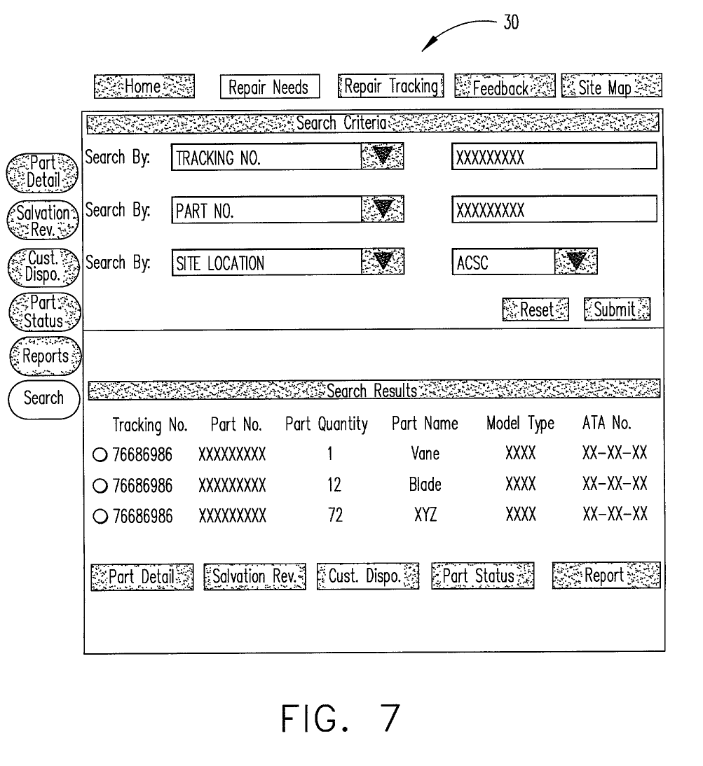

Server 14 is configured with databases and applications that allow users and customers to access and store information regarding component non-serviceability and repair needs. For example, in one embodiment, server 14 includes a part detail application 20 illustrated in FIG. 2, a component non-serviceability review application 22 illustrated in FIG. 3, a customer disposition determination application 24 illustrated in FIG. 4, a part status application 26 illustrated in FIG. 5, an ability to define a customized output 28 illustrated in FIG. 6, and a search capability feature 30 illustrated in FIG. 7. In one embodiment, the server 14 and the collaborative partners 16A-16N communicate with each other through the Internet and supply information from their local systems into the centralized database.

A user can access the system 10 at one of the users 16A-16N, typically via an external interface such as the Internet. Once the user is verified as an authorized user, access is granted to the database or application needed by the user. For example, the user can access a part detail query form via input wizard 18, to view screen 20 such as is illustrated in FIG. 2. Exemplary screen 20 walks the user through a series of queries and selection options to retrieve the necessary information from the user regarding the component part detail.

Should the user select the engineering or development review 22, the exemplary screen illustrated in FIG. 3 is displayed, again requesting relevant information from the user. Besides details of the non-serviceable part and its location at the user's facility, an engineering or development review or recommendation can be made. As with the part detail described above, the part location is always physically tracked during the query screens.

When the part detail is reviewed, a proposed action or a proposed review disposition may be made. At the customer disposition exemplary screen 24 in FIG. 4, the customer can approve or reject the proposed action or proposed review disposition downloaded from the central database. The choice made by the customer is input and uploaded to the server 14.

Depending on the action taken, the non-serviceable component may be moved to another location. The status and location of the part is tracked by responding to the queries in exemplary screen 26 of FIG. 5. Included in screen 26 are many of the same identification fields as described above.

FIG. 6 is an exemplary screen embodiment of selections for creating a customized output of non-serviceable components and repair needs. By selecting information based on particular dates or data, a customized output can be generated. The customized output can be used to make determinations on the need for engineering or development programs. This can result in preservation of revenue opportunities. The customized output is printable, or may be emailed to other parties.

By setting search criteria at exemplary screen 30 in FIG. 7, non-serviceable component details are retrievable. The search capability allows a user to search for parts based on certain, inputted, criteria. For example, a user can find all available parts meeting a specified set of criteria.

Although the configuration described herein refers to a server 14 being geographically and physically separated from each user link, this does not preclude integrating the website data and information into each of the user sites to create a stand-alone system. In such a case, it is feasible to use a network to update the information resident in each of the computers. It is also feasible to download website information and data to the user computer each time component information is to be input.

Since component recovery is typically less expensive than component replacement, it is beneficial to all users to share their component non-serviceability data. The central database streamlines repair determinations, and can speed up repair development programs to preserve revenue opportunities. The business application developed herein allows users to collaborate online with geographically and/or physically remote users to track component non-serviceability and repair needs. The server 14 can be used to offer repair development information and services between users and to bring separate users together in any manufacturing or service industry. The separate users can collaborate remotely to track component non-serviceability and repair development opportunities, to increase knowledge, and to decrease costs.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system configured for documenting and communicating component engineering and development needs, comprising:
a server configured with a database of part related data, said server capable allowing a user to input information into the database for upload to said server including component non-serviceability documentation of said user and allowing a user to download information from the database including repair development opportunities;
at least one computer;
an input means for filtering information between the user and the server; and
an interface between the at least one computer and the server.

2. A system as claimed in claim 1 wherein the part related data is reviewed for potential engineering opportunities.

3. A system as claimed in claim 1 wherein the input means comprises a wizard.

4. A system as claimed in claim 1 wherein access to said server is configured to be secured by user password.

5. A system as claimed in claim 1 wherein said user comprises multiple users.

6. A system as claimed in claim 5 wherein the database is owned by an owner entity.

7. A system as claimed in claim 6 wherein the multiple users comprise users internal to the owner entity and users external to the owner entity.

8. A system as claimed in claim 1 wherein the interface is provided by web pages that can be transmitted from the database to the user.

9. A system as claimed in claim 1 wherein the component engineering and development needs comprise component non-serviceability and repair needs.

10. A system as claimed in claim 1 wherein said server is configured to store and download text and digital images.

11. A method for documenting and communicating component engineering and development needs of internal users and external users using a system which includes a server and at least one client system, the method comprising the steps of:
uploading user information to the server;
downloading from the server, web pages configured to direct internal and external users to a database and related applications within the server, the database configured with component engineering and development data;
uploading user selections input into the web pages to the server;
downloading from the server component engineering and development opportunities responsive to the component engineering and development data; and
using an input means to filter information between the user and the server.

12. A method as claimed in claim 11 further comprising the step of configuring the server to be secured by user password.

13. A method as claimed in claim 11 wherein the component engineering and development needs comprises component non-serviceability and repair needs.

14. A method as claimed in claim 11 further comprising the step of configuring the server to store and download text and digital images.

15. A method as claimed in claim 11 wherein the step of downloading from the server, web pages configured to direct internal and external users to a database and related applications within the server, further comprises the step of downloading from the server, web pages configured to direct internal and external users to a database and related applications within the server, the related applications including a part detail application, an engineering or development review application, a customer disposition determination application, and a part status application.

16. A method as claimed in claim 11 further comprising the step of configuring the server to allow for a customized output feature.

17. A method as claimed in claim 11 further comprising the step of configuring the server to have a search capability for finding components meeting a specified set of criteria.
